(19) United States
(12) Patent Application Publication
(10) Pub. No.: US 2018/0373719 A1
(43) Pub. Date: Dec. 27, 2018

(54) DYNAMIC REPRESENTATION OF SUGGESTED QUERIES

(71) Applicant: Microsoft Technology Licensing, LLC, Redmond, WA (US)

(72) Inventors: Jamil VALLIANI, Kirkland, WA (US); Arun SACHETI, Sammamish, WA (US); Vincent Kin-Wah LEUNG, Bellevue, WA (US); Nektarios IOANNIDES, Seattle, WA (US); Nan WU, Kirkland, WA (US); Ryuichi HIRANO, Renton, WA (US); Christopher WALSVICK, Mercer Island, WA (US); Soohoon CHO, Bellevue, WA (US)

(73) Assignee: Microsoft Technology Licensing, LLC, Redmond, WA (US)

(21) Appl. No.: 15/630,627

(22) Filed: Jun. 22, 2017

(51) Int. Cl. G06F 17/30

(52) U.S. Cl. CPC G06F 17/3053; G06F 17/30253; G06F 17/30047; G06F 17/30672

(57) ABSTRACT

Examples of the present disclosure describe systems and methods for dynamic representation of suggested queries. In an example, a suggested search query may be generated to provide a user with an alternative query that may be used by the user to adjust, refine, or vary a search. The suggested search query may be displayed to the user in the form of suggested content, wherein the suggested content may comprise a compilation or a collage of search results associated with the suggested search query. A suggested search query may be generated based on one or more datasets, wherein a dataset may provide different variations for a given search query. Accordingly, search queries from different datasets may be incorporated into search results, thereby providing diverse and dynamic search suggestions to the user.

### BACKGROUND

A user may provide a search query to a search provider, which the search provider may use to provide relevant search results in response. In examples, the search provider may also provide one or more suggested search queries to the user, thereby enabling the user to perform other searches based on the suggested search queries. However, merely providing suggested search queries may not offer much insight to the user with regard to the search results that may be associated with the suggested search query.

It is with respect to these and other general considerations that the aspects disclosed herein have been made. Also, although relatively specific problems may be discussed, it should be understood that the examples should not be limited to solving the specific problems identified in the background or elsewhere in this disclosure.

### SUMMARY

Examples of the present disclosure describe systems and methods for dynamic representation of suggested queries. In an example, a suggested search query may be generated for a given search query. The suggested search query may be related to the given search query, thereby providing a user with an alternative query that may be used by the user to adjust, refine, or vary a search. The suggested search query may be displayed to the user in the form of suggested content, wherein the suggested content may comprise a compilation or a collage of search results associated with the suggested search query. As a result, the user may be better able to determine whether the suggested search query would return search results that may be of interest, as compared to merely viewing the text of the search query.

Suggested search queries may be generated based on one or more datasets, wherein a dataset may provide different variations for a given search query. As an example, a search query may be comprised of an entity and/or an intent (e.g., an entity may be “car” and an intent may be “red”). A dataset may comprise search query suggestions that vary the entity of a search query, the intent of a search query, the scope of a search query, or may provide related search queries. Accordingly, search queries from the datasets may be incorporated into search results as suggested content so as to provide diverse and dynamic search suggestions to the user.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the description which follows and, in part, will be apparent from the description, or may be learned by practice of the disclosure.

### BRIEF DESCRIPTION OF THE DRAWINGS

Non-limiting and non-exhaustive examples are described with reference to the following figures.

FIG. 1 illustrates an overview of an example system for dynamic representation of suggested queries.

FIG. 2 illustrates an overview of an example method for generating a dynamic representation of a suggested query.

FIG. 3 illustrates an overview of an example method for generating a dataset used to provide dynamic representations of suggested queries.

FIGS. 4A-4C illustrate overviews of example user interfaces for dynamic representations of suggested queries.

FIG. 5 is a block diagram illustrating example physical components of a computing device with which aspects of the disclosure may be practiced.

FIGS. 6A and 6B are simplified block diagrams of a mobile computing device with which aspects of the present disclosure may be practiced.

FIG. 7 is a simplified block diagram of a distributed computing system in which aspects of the present disclosure may be practiced.

FIG. 8 illustrates a tablet computing device for executing one or more aspects of the present disclosure.

### DETAILED DESCRIPTION

Various aspects of the disclosure are described more fully below with reference to the accompanying drawings, which form a part hereof, and which show specific example aspects. However, different aspects of the disclosure may be implemented in many different forms and should not be construed as limited to the aspects set forth herein; rather, these aspects are provided so that this disclosure will be thorough and complete, and will fully convey the scope of the aspects to those skilled in the art. Aspects may be practiced as methods, systems or devices. Accordingly, aspects may take the form of a hardware implementation, an entirely software implementation or an implementation combining software and hardware aspects. The following detailed description is, therefore, not to be taken in a limiting sense.

In an example, a user may use a client device to perform a search for a search query using a search provider. The search may be for images, videos, or other visual content. In another example, the search may be for textual content. In some examples, the search query may be received as a text input, as a voice input, or as an image input, among other inputs. In examples, the search provider may provide one or more results in response to the query, wherein the results may comprise visual content, textual content, or any combination thereof. According to aspects disclosed herein, the search provider may also provide suggested content, wherein the suggested content may comprise one or more suggested search queries. However, merely providing a suggested search query to a user in a textual form may not offer much insight to the user about whether the query would provide search results in which the user may be interested.

Accordingly, the present disclosure provides systems and methods for dynamic representation of suggested queries. In an example, suggested content may comprise a compilation of one or more search results associated with a suggested query. As such, the suggested content may be provided to a user device for display to a user, thereby enabling the user to view results associated with a suggested query without first needing to perform the suggested query with the search provider. For example, suggested content for a suggested query relating to an image or video search may comprise a compilation or collage of visual content associated with the suggested query. A collage of images or thumbnails may be generated based on the search results associated with the suggested query. As an example, the collage may comprise multiple overlapping and/or neighboring tiles, each of which may further comprise visual content (e.g., search results). In another example, results for a suggested query may be associated with colors, icons, or other visual elements, such that the visual elements may be used to generate the suggested content. For example, suggested content may comprise any media that can be represented using an image, such as a video, a news article, or a commercial product, among other examples. In some examples, the suggested content may be interactive, wherein the suggested content may comprise multiple elements, each of which may be associated with a different suggested search query. In an example, a user may hover over an element of the suggested content, thereby causing a textual display of an associated query suggestion to update to the query suggestion associated with the element with which the user has interacted. It will be appreciated that other techniques may be used without departing from the spirit of this disclosure.

In some examples, the search provider may provide suggested content in addition to search results. As an example, rather than merely displaying suggested content above or to the side of search results that are responsive to a search query, the suggested content may be incorporated into the search results. Thus, as the user scrolls through the search results, the user may periodically encounter suggested content. By contrast, if the suggested content was only included at the top of the search results, the user may need to return to the top of the page in order to access the suggested content. Further, providing suggested content among the search results may enable more suggested content to be displayed, as the amount of suggested content that may be displayed to the user may increase with the amount of search results that are viewed by the user.

In some examples, the ratio between the suggested content and the search results displayed to the user may be varied. As an example, a lower ratio of suggested content may be displayed among results that are likely to be relevant to a user's search query (e.g., toward the top of the search results, assuming the search results are ordered according to descending relevance). By contrast, a higher ratio of suggested content may be displayed among less relevant search results, thereby providing a higher degree of suggested content when the user is more likely to engage with the suggested content. In other examples, suggested content may be randomly or systematically placed among the search results. In one example, suggested content may reside in a similar or constant position, wherein the suggested content may be updated to relate to different query suggestions. As a result, the suggested content may occupy a similar display region while providing different search query suggestions. For example, suggested content that remains at a similar display region may be occasionally updated as a user scrolls through a display of search results. The suggested content may be updated based on a user's scroll position, based on an evaluation of the image search results that are currently displayed, or based on the relevance of the currently-displayed results in relation to the initial search query. It will be appreciated that while example techniques are disclosed herein, suggested content may be provided based on any of a variety of other factors, including, but not limited to, a user's browsing habits, the type of client device, a user's location, etc.

Suggested content may be generated using any of a variety of techniques. As an example, suggested content may be generated from a dataset, wherein the dataset may comprise search queries that are associated with a given search query. In some examples, an entity and an intent may be identified for the given search query. As an example, for a search query comprising “fast red car,” the entity may be determined to be “car,” whereas a plurality of intents may be identified to be “fast” and “red.” Thus, a dataset may comprise search queries that vary an intent of the given search query (e.g., a “blue” or “big” car), that vary an entity of the given search query (e.g., a fast red “boat” or “plane”), that vary a scope of the given search query (e.g., a “sporty” fast red car), or that are related to the given search query (e.g., “formula one car,” “speeding fire truck,” etc.). It will be appreciated that while examples are described, a wide variety of variations and domains may be used according to aspects disclosed herein.

A dataset may be generated based on analyzing query logs comprising search queries from one or more users of a search provider. In some examples, the search queries may be anonymized such that user identities may not be determinable from the query logs. A query log may be analyzed to identify query reformulations, wherein a user may revise a query in order to better describe the subject matter for which the user is searching or to search for subject matter relating to a different but related query. In some examples, a query reformulation may be identified based on the degree to which search terms of queries overlap or the amount of overlap between different results sets, among other techniques. In another example, a dataset may be generated based on a knowledge graph, wherein similar entities and/or intents may be associated with other similar entities and/or intents. While example techniques are described herein, it will be appreciated that other techniques may be used to generate a dataset.

Multiple datasets may be used to generate suggested content. In some examples, suggested content may be generated by cycling through a plurality of datasets that have relevant search query suggestions for a given search query. In other examples, a dataset may be selected based on any of a variety of factors, including, but not limited to, relevance to the given search query or a user's browsing history (e.g., whether the user is likely to engage with suggestions from a dataset, whether the user has already searched for queries from a dataset, etc.). In an example, suggested queries within a dataset may be ordered or selected based on relevance or whether users of the search provider have identified the suggested query as being relevant, among other factors.

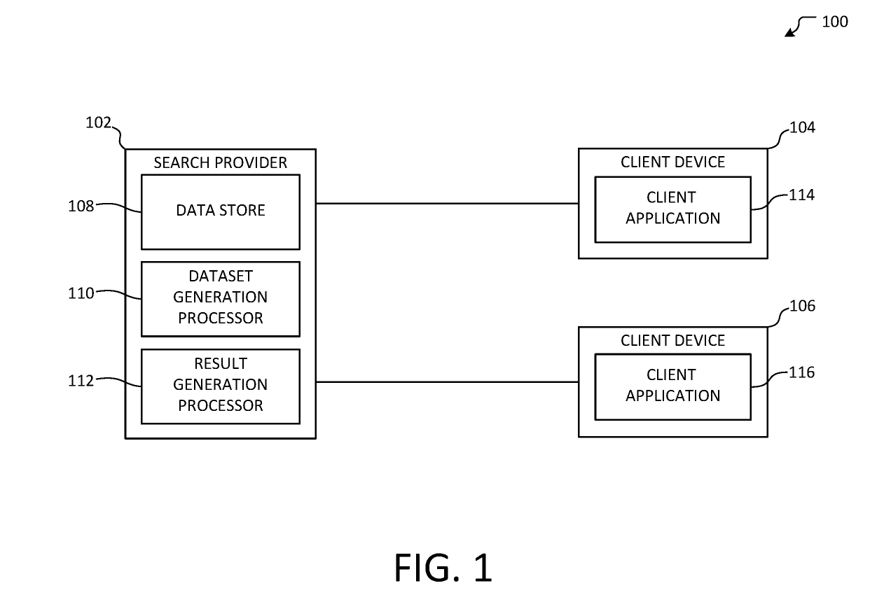

FIG. 1 illustrates an overview of an example system 100 for dynamic representation of suggested queries. As illustrated, system 100 comprises search provider 102 and client devices 104 and 106. Search provider 102 may receive search queries from and provide search results to client devices 104 and 106. As an example, search provider 102 may be an internet search engine, a social media search engine, or a video search engine. A search query may be a text input, a voice input, or an image input, among other inputs. In some examples, a voice input may be analyzed to generate a speech recognition result for identifying search results, or an image input may be analyzed to identify image features which may be used to identify responsive or similar image search results. It will be appreciated that other search inputs and/or query techniques may be used according to aspects disclosed herein.

In some examples, client devices 104 and 106 may each be any of a variety of computing devices, including, but not limited to, a mobile computing device, a desktop computing device, a tablet computing device, or a laptop computing device. Client devices 104 and 106 may use client applications 114 and 116, respectively, to access search provider 102. As an example, client applications 114 and 116 may each be any of a variety of applications, including, but not limited to, a web browsing application, a social media application, or a productivity suite application.

Search provider 102 comprises data store 108, dataset generation processor 110, and result generation processor 112. Data store 108 may be a local storage device or database of search provider 102. It will be appreciated that while data store 108 is illustrated as part of search provider 102, other examples may comprise remote storage or may use storage of client devices 104 and/or 106, among other storage. In an example, data store 108 may comprise one or more datasets, each of which may comprise query suggestions according to aspects disclosed herein. In another example, data store 108 may comprise user data, including, but not limited to, user search query logs and/or user query suggestion engagement data. Dataset generation processor 110 may generate one or more datasets according to aspects disclosed herein. As an example, dataset generation processor 110 may access data stored by data store 108 in order to generate one or more datasets comprising search query suggestions. Dataset generation processor 110 may evaluate search query logs from data store 108 in order to identify queries having related entities, intents, and/or topics. Dataset generation processor 110 may store generated datasets in data store 108.

Result generation processor 112 may generate a result set for a given search query. In an example, a search query may be received from one of client devices 104 and 106. The query may comprise one or more terms, and may be used by result generation processor 112 to identify search results that are responsive to the search query. According to aspects disclosed herein, result generation processor 112 may provide suggested content. The suggested content may comprise one or more suggested search queries, as may be determined from one or more datasets (e.g., as may be stored by data store 108 and/or generated by dataset generation processor 110). The suggested content may be provided as a collage of visual content, thereby providing a user of client devices 104 and/or 106 an indication of the search results associated with a suggested search query. It will be appreciated that suggested queries and/or suggested content may be generated based on preexisting datasets as described above, or may be determined dynamically when generating or providing the search results, among other techniques.

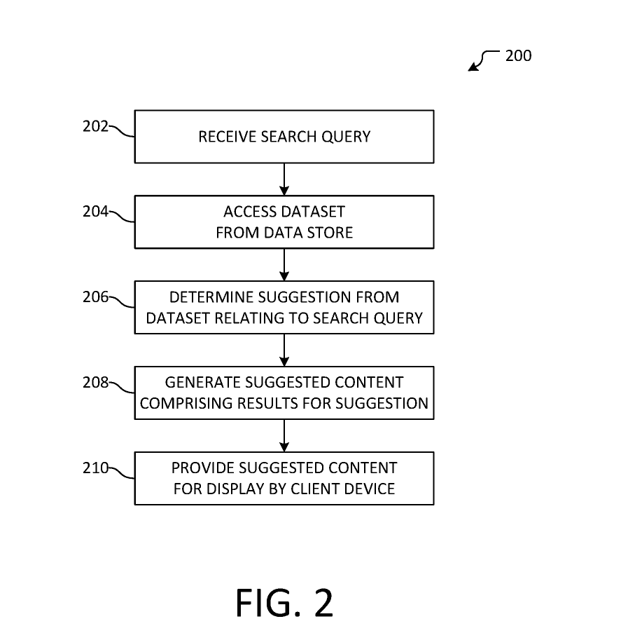

FIG. 2 illustrates an overview of an example method 200 for generating a dynamic representation of a suggested query. In an example, method 200 may be performed by one or more computing devices. In some examples, method 200 may be performed by result generation processor 112 in FIG. 1. Method 200 begins at operation 202, where a search query may be received. In an example, the search query may be received from a client device, such as one of client devices 104 and 106 in FIG. 1. As discussed above, the search query may comprise a variety of terms, such as one or more entities and/or intents.

Moving to operation 204, a dataset may be accessed from a data store. In an example, the data store may be data store 108 in FIG. 1. Accessing the dataset may comprise selecting a dataset from one of a plurality of datasets, wherein each dataset may comprise search query suggestions relating to varying intents, varying entities, varying scopes, and/or related queries, among others. In some examples, the dataset may be randomly selected from the plurality of datasets or may be selected based on an ordering among the datasets (e.g., such that each dataset may be accessed in turn before returning to a previously-accessed dataset), among other selection techniques. In some examples, it may be determined that a dataset does not comprise suggested queries for the received search query. As a result, a different dataset may be selected from the data store.

At operation 206, a suggested query for the received search query may be determined from the accessed dataset. In some examples, determining the suggested query may comprise evaluating a relevance metric generated based on a suggested query and the received search query. In other examples, the suggested query may be determined based on a likelihood that the user will engage with the suggested query. The likelihood may be determined based on user data, such as previous search queries, browsing history, or identified user interests, among other data. In another example, the likelihood may be based on interactions of other users with the suggested queries in the dataset, such as which suggestions were more likely to receive a user's attention. It will be appreciated that any of a variety of other techniques may be used to determine a query suggestion from the dataset.

Flow progresses to operation 208, where suggested content may be generated. The suggested content may comprise search results for the query suggestion that was determined at operation 206. In an example, the query suggestion may be a query suggestion for an image search, wherein the image search results for the query suggestion may comprise one or more images. Accordingly, generating the suggested content may comprise generating a collage of some of the image search results, such that multiple image search results may be visible as part of the suggested content. In another example, the query suggestion may be a query suggestion for a video search, such that the suggested content may comprise a plurality of thumbnails for videos that are responsive to the query suggestion. While suggested content comprising a collage is described, it will be appreciated that other suggested content may be generated, including, but not limited to, a word cloud of the suggested results or a topic graph.

At operation 210, the suggested content may be provided for display by the client device. The suggested content may be provided as an image, as a video, as text, as a code segment, or a combination thereof, among other data formats. As an example, an XML, JSON, or HTML code segment may be generated indicating a plurality of resources that should be accessed by the client device. The client device may parse or interpret the received code segment, retrieve the indicated resources, and generate a display of the suggested content for the user. In another example, an image may be provided to the client device, wherein the image comprises a collage that was generated as described above. The client device may incorporate the image among other search results according to aspects disclosed herein. Flow terminates at operation 210.

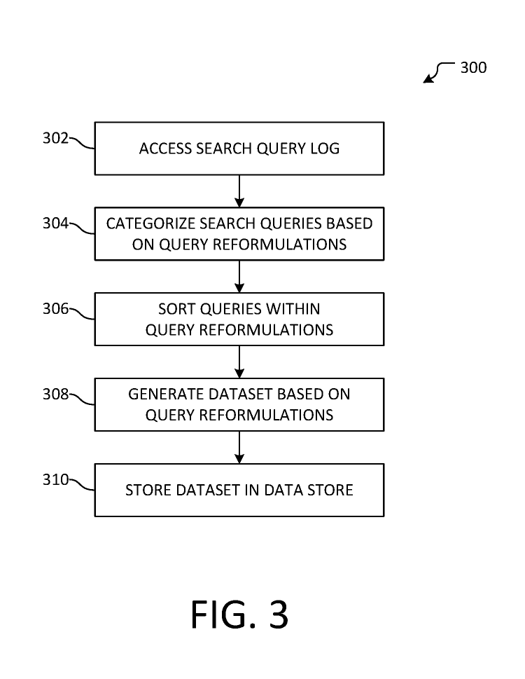

FIG. 3 illustrates an overview of an example method 300 for generating a dataset used to provide dynamic representations of suggested queries. In an example, method 300 may be performed by one or more computing devices. In some examples, method 300 may be performed by dataset generation processor 110 in FIG. 1. Method 300 begins at operation 302, where a search query log may be accessed. In some examples, the search query log may comprise search queries from one or more users. The queries may be anonymized such that user identities may not be determinable from the query logs. In other examples, the search query log may comprise information relating to user engagement with search query results or timestamp information indicating how recent a query was made, among other information.

At operation 304, search queries in the search query log may be categorized. In an example, categorizing the search queries may be performed based on identify query reformulations. A query reformulation may be identified based on the similarity of query terms, the similarity of the result set, and/or the similarity of the results viewed by the user, among other techniques. Based on categorizing search queries based on query reformulations, search queries within a given category may relate to similar entities, intents, and/or topics while comprising varying keywords.

Moving to operation 306, queries of a query reformulation category may be sorted. In some examples, sorting may be performed based on user-specific criteria (e.g., a user's browsing history, a user's previous search queries, etc.). In other examples, sorting may be performed based on relevance to a given search query. In an example, some queries may be filtered or omitted, such as queries that comprise misspelled terms are that comprise terms that are uncommon or unlikely to be relevant. It will be appreciated that queries may be pre-sorted or may be sorted when generating query suggestions for a user, among other times.

At operation 308, a dataset may be generated based on the query reformulations. In some examples, multiple datasets may be generated, wherein each dataset may comprise queries relating to a different type of variation (e.g., varying intent, entity, scope, etc.). Generating the dataset may comprise evaluating queries within a query reformulation to determine how each query relates to other queries of the reformulation. For example, it may be determined that a certain subset of query reformulations relate to a similar entity with varying intents, such that a dataset comprising query suggestions having varying intents may be generated. In another example, it may be determined that a subset of query reformulations relate to a similar intent but with varying entities, such that a dataset comprising query suggestions having varying entities may be generated. While example datasets are described herein, it will be appreciated that any of a variety of datasets may be generated.

Moving to operation 310, the generated dataset may be stored in a data store. In an example, the data store may be data store 108 in FIG. 1. Storing the dataset in the data store may comprise associating the dataset with a type (e.g., varying entity, varying intent, etc.), with a set of search query topics, or with a user demographic, among others. In some examples, the data store may be a local storage device, may be a remote storage device, or any combination thereof. It will be appreciated that method 300 is provided as an example and that other techniques may be used to generate a dataset. For example, a knowledge graph may be used to identify related terms or user feedback may be analyzed to determine whether suggested search queries should be incorporated into a dataset. Flow terminates at operation 310.

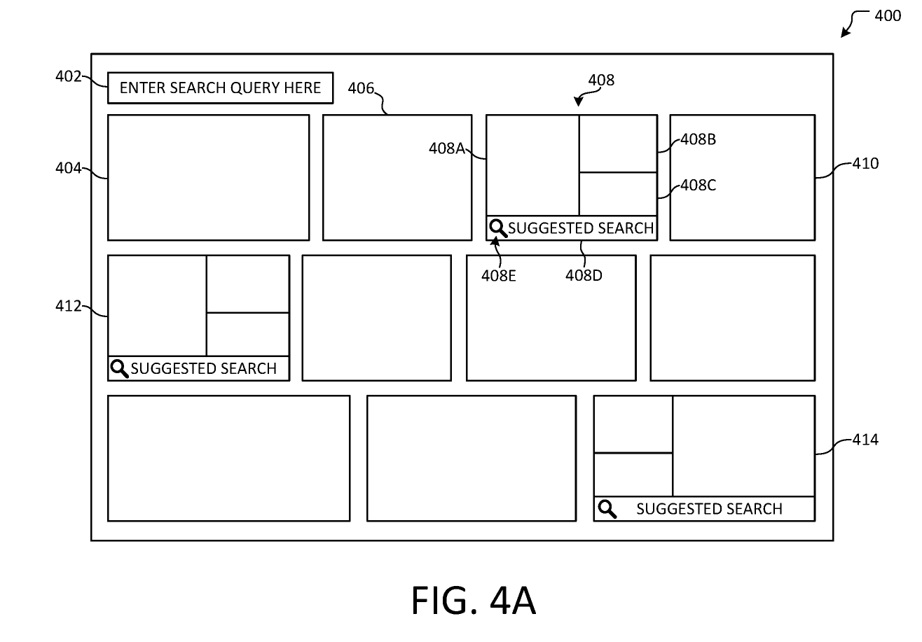

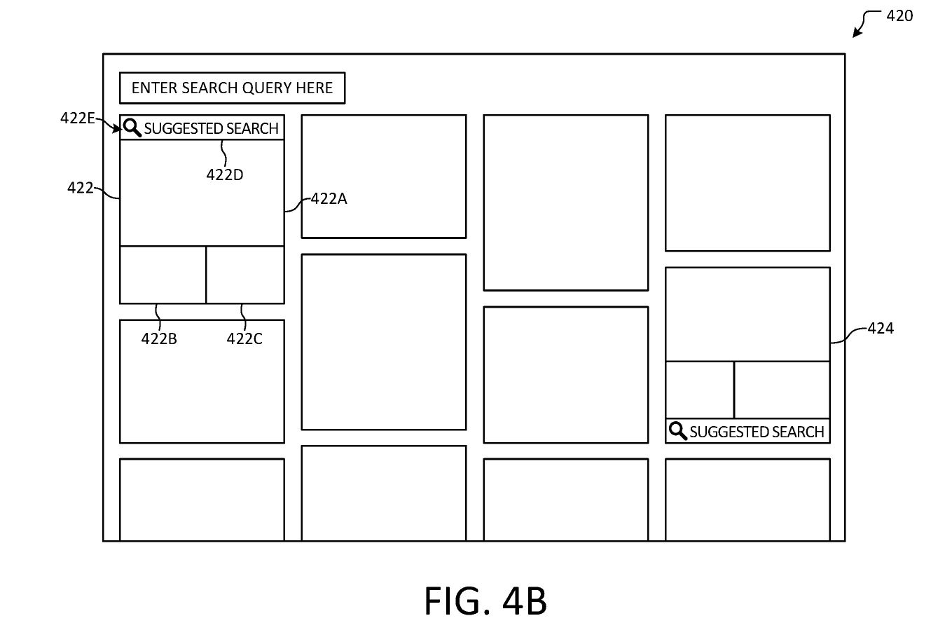

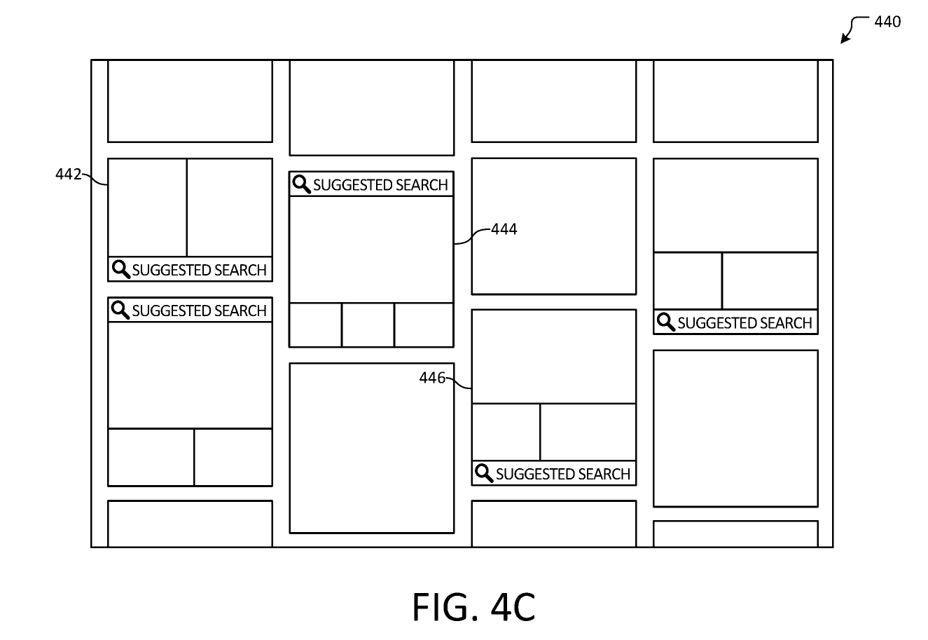

FIGS. 4A-4C illustrate overviews of example user interfaces for dynamic representations of suggested queries. The example user interfaces may be displayed by a client device (e.g., client devices 104 or 106 in FIG. 1) displaying search results comprising suggested content according to aspects disclosed herein. FIG. 4A comprises user interface 400, which illustrates a row-based image search result display. User interface 400 may be termed “row-based,” as elements 404-414 each have a similar height. As a result, elements 404-414 may be organized into rows, while the respective widths of the elements may vary according to the aspect ratio of each element. By contrast, a display comprising search results having similar widths may be termed a “column-based” search result display, which will be discussed in greater detail below with respect to FIG. 4B.

User interface 400 comprises search bar 402, which may receive user input comprising one or more terms according to aspects disclosed herein. A user may enter a search query in search bar 402, thereby causing image search results that are responsive to the search query to be displayed in user interface 400 (e.g., elements 404-414). As illustrated, suggested content 408, 412, and 414 may be displayed among image search results 404, 406, and 410. In some examples, suggested content 408, 412, and 414 may be randomly distributed, or maybe positioned within user interface 400 according to a variety of factors (e.g., where it is likely a user will engage with the content, such that the suggested content is proximate to a related image search result, etc.).

With reference to suggested content 408, which may be a similar example to suggested content 412 and 414, suggested content 408 comprises main image 408A, secondary images 408B and 408C, suggested search 408D, and suggested search indicator 408E. In an example, suggested search 408D may comprise the text of one or more search terms of a suggested search query. Main image 408A and secondary images 408B and 408C may be image search results that are responsive to suggested search 408D. In an example, main image 408A and secondary images 408B and 408C may be selected based on relevance to suggested search 408D, or may be selected based on a determination that they are representative of the image search results that are responsive to suggested search 408D. Suggested search 408D may comprise one or more suggested search terms, which may have been generated according to aspects disclosed herein. Suggested search indicator 408E may be provided to indicate to a user of user interface 400 that suggested content 408 is a search suggestion rather than an image search result (e.g., image search results 404, 406, and 410). It will be appreciated that suggested content may include additional images (e.g., more than two secondary images) or may have similarly or differently sized images.

In some examples, suggested content 408, 412, and 414 may be generated from the same dataset or from different datasets. For example, suggested content 408 may be a search query suggestion with an entity that varies from the search query entered in search box 402, while suggested content 412 may be a search query suggestion with an intent that varies from the search query entered in search box 402. While FIGS. 4A-4C are discussed in the context of image search results, it will be appreciated that similar techniques may be applied to search results for other types of content.

Moving to FIG. 4B, user interface 420 is depicted, which comprises a column-based view of search results. As discussed above, user interface 420 is termed a column-based view, as the elements have similar widths, while the heights may be permitted to vary. In some examples, padding may be introduced to the search results so as to generate a view in which both the rows and columns are similarly sized while still enabling the aspect ratio of each result to remain consistent. Similar to FIG. 4A, FIG. 4B comprises image search results and suggested content 422 and 424. The suggested content may be randomly distributed among the image search results, or may be placed according to other factors.

Similar to suggested content 408 in FIG. 4A, suggested content 422 comprises main image 422A, secondary images 422B and 422C, suggested search 422D, and suggested search indicator 422E. As compared to suggested content 408, suggested content 422 may have a vertical layout, wherein main image 422A is above secondary images 422B and 422C, whereas secondary images 408B and 408C are illustrated to the side of main image 408A in FIG. 4A. Suggested content 424 is similar to suggested content 422, though the suggested search text is depicted at the bottom of suggested content 424, whereas it is at the top of suggested content 422. As such, it will be appreciated that elements of suggested content may be arranged using any of a variety of techniques.

With respect to FIG. 4C, user interface 440 comprises a column-based view of image search results, wherein user interface 400 illustrates a view that is further down the image search results. In an example, a higher ratio of suggested content may be displayed among the image search results as the user scrolls further down the page, as it may be less likely that the image search results are responsive to the user's search query. Suggested content 442 illustrates another example arrangement, wherein two similarly-sized images may comprise suggested content. In another example, suggested content 444 comprises three secondary images and one main image. In some examples, secondary images may not be the same size, as illustrated by suggested content 446.

While example user interface elements, content, and techniques have been discussed above with respect to FIGS. 4A-4C, it will be appreciated that alternative user interface elements, content, and/or techniques may be used to generate and/or provide suggested content without departing from the spirit of this disclosure.

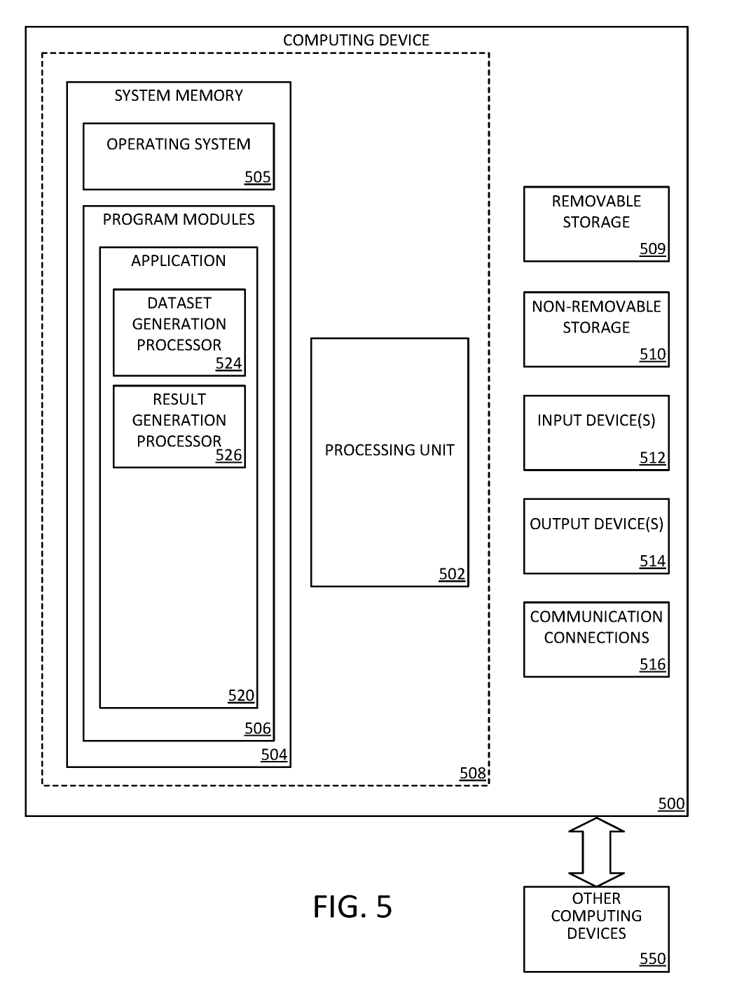

FIGS. 5-8 and the associated descriptions provide a discussion of a variety of operating environments in which aspects of the disclosure may be practiced. However, the devices and systems illustrated and discussed with respect to FIGS. 5-8 are for purposes of example and illustration and are not limiting of a vast number of computing device configurations that may be utilized for practicing aspects of the disclosure, described herein.

FIG. 5 is a block diagram illustrating physical components (e.g., hardware) of a computing device 500 with which aspects of the disclosure may be practiced. The computing device components described below may be suitable for the computing devices described above. In a basic configuration, the computing device 500 may include at least one processing unit 502 and a system memory 504. Depending on the configuration and type of computing device, the system memory 504 may comprise, but is not limited to, volatile storage (e.g., random access memory), non-volatile storage (e.g., read-only memory), flash memory, or any combination of such memories. The system memory 504 may include an operating system 505 and one or more program modules 506 suitable for performing the various aspects disclosed herein such as dataset generation processor 524 and result generation processor 526. The operating system 505, for example, may be suitable for controlling the operation of the computing device 500. Furthermore, embodiments of the disclosure may be practiced in conjunction with a graphics library, other operating systems, or any other application program and is not limited to any particular application or system. This basic configuration is illustrated in FIG. 5 by those components within a dashed line 508. The computing device 500 may have additional features or functionality. For example, the computing device 500 may also include additional data storage devices (removable and/or non-removable) such as, for example, magnetic disks, optical disks, or tape. Such additional storage is illustrated in FIG. 5 by a removable storage device 509 and a non-removable storage device 510.

As stated above, a number of program modules and data files may be stored in the system memory 504. While executing on the processing unit 502, the program modules 506 (e.g., application 520) may perform processes including, but not limited to, the aspects, as described herein. Other program modules that may be used in accordance with aspects of the present disclosure may include electronic mail and contacts applications, word processing applications, spreadsheet applications, database applications, slide presentation applications, drawing or computer-aided application programs, etc.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. For example, embodiments of the disclosure may be practiced via a system-on-a-chip (SOC) where each or many of the components illustrated in FIG. 5 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 500 on the single integrated circuit (chip). Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

The computing device 500 may also have one or more input device(s) 512 such as a keyboard, a mouse, a pen, a sound or voice input device, a touch or swipe input device, etc. The output device(s) 514 such as a display, speakers, a printer, etc. may also be included. The aforementioned devices are examples and others may be used. The computing device 500 may include one or more communication connections 516 allowing communications with other computing devices 550. Examples of suitable communication connections 516 include, but are not limited to, radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 504, the removable storage device 509, and the non-removable storage device 510 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 500. Any such computer storage media may be part of the computing device 500. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

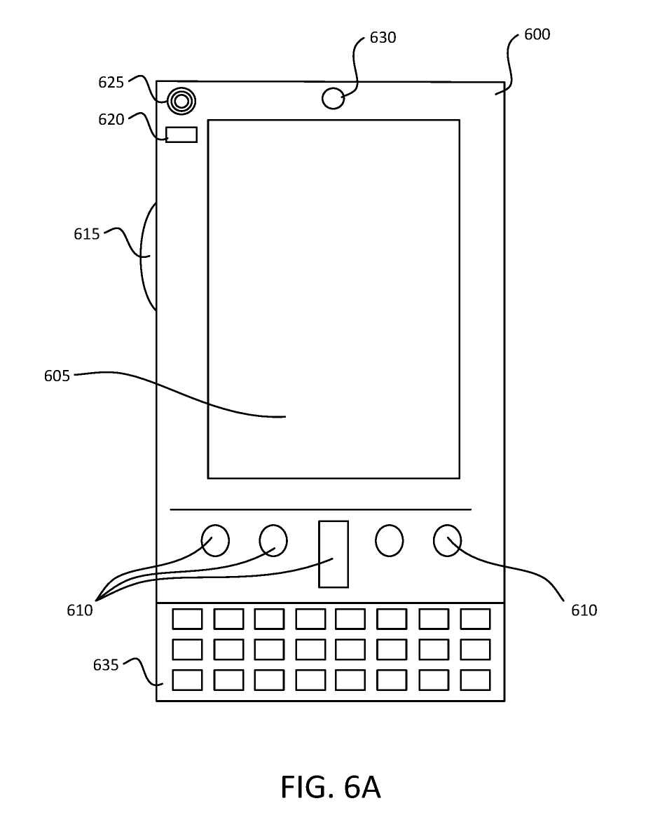

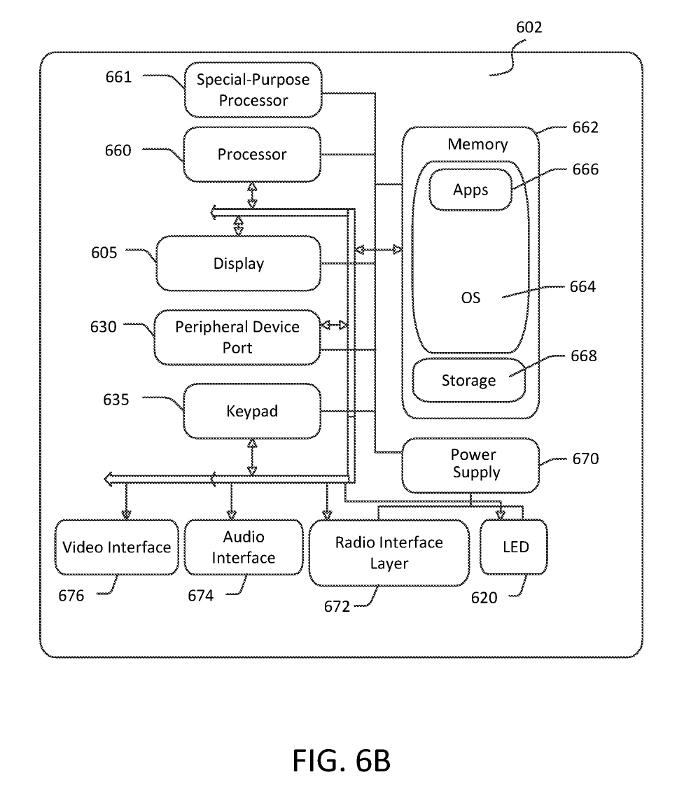

FIGS. 6A and 6B illustrate a mobile computing device 600, for example, a mobile telephone, a smart phone, wearable computer (such as a smart watch), a tablet computer, a laptop computer, and the like, with which embodiments of the disclosure may be practiced. In some aspects, the client may be a mobile computing device. With reference to FIG. 6A, one aspect of a mobile computing device 600 for implementing the aspects is illustrated. In a basic configuration, the mobile computing device 600 is a handheld computer having both input elements and output elements. The mobile computing device 600 typically includes a display 605 and one or more input buttons 610 that allow the user to enter information into the mobile computing device 600. The display 605 of the mobile computing device 600 may also function as an input device (e.g., a touch screen display). If included, an optional side input element 615 allows further user input. The side input element 615 may be a rotary switch, a button, or any other type of manual input element. In alternative aspects, mobile computing device 600 may incorporate more or less input elements. For example, the display 605 may not be a touch screen in some embodiments. In yet another alternative embodiment, the mobile computing device 600 is a portable phone system, such as a cellular phone. The mobile computing device 600 may also include an optional keypad 635. Optional keypad 635 may be a physical keypad or a “soft” keypad generated on the touch screen display. In various embodiments, the output elements include the display 605 for showing a graphical user interface (GUI), a visual indicator 620 (e.g., a light emitting diode), and/or an audio transducer 625 (e.g., a speaker). In some aspects, the mobile computing device 600 incorporates a vibration transducer for providing the user with tactile feedback. In yet another aspect, the mobile computing device 600 incorporates input and/or output ports, such as an audio input (e.g., a microphone jack), an audio output (e.g., a headphone jack), and a video output (e.g., a HDMI port) for sending signals to or receiving signals from an external device.

FIG. 6B is a block diagram illustrating the architecture of one aspect of a mobile computing device. That is, the mobile computing device 600 can incorporate a system (e.g., an architecture) 602 to implement some aspects. In one embodiment, the system 602 is implemented as a “smart phone” capable of running one or more applications (e.g., browser, e-mail, calendaring, contact managers, messaging clients, games, and media clients/players). In some aspects, the system 602 is integrated as a computing device, such as an integrated personal digital assistant (PDA) and wireless phone.

One or more application programs 666 may be loaded into the memory 662 and run on or in association with the operating system 664. Examples of the application programs include phone dialer programs, e-mail programs, personal information management (PIM) programs, word processing programs, spreadsheet programs, Internet browser programs, messaging programs, and so forth. The system 602 also includes a non-volatile storage area 668 within the memory 662. The non-volatile storage area 668 may be used to store persistent information that should not be lost if the system 602 is powered down. The application programs 666 may use and store information in the non-volatile storage area 668, such as e-mail or other messages used by an e-mail application, and the like. A synchronization application (not shown) also resides on the system 602 and is programmed to interact with a corresponding synchronization application resident on a host computer to keep the information stored in the non-volatile storage area 668 synchronized with corresponding information stored at the host computer. As should be appreciated, other applications may be loaded into the memory 662 and run on the mobile computing device 600 described herein (e.g., search engine, extractor module, relevancy ranking module, answer scoring module, etc.).

The system 602 has a power supply 670, which may be implemented as one or more batteries. The power supply 670 might further include an external power source, such as an AC adapter or a powered docking cradle that supplements or recharges the batteries.

The system 602 may also include a radio interface layer 672 that performs the function of transmitting and receiving radio frequency communications. The radio interface layer 672 facilitates wireless connectivity between the system 602 and the “outside world,” via a communications carrier or service provider. Transmissions to and from the radio interface layer 672 are conducted under control of the operating system 664. In other words, communications received by the radio interface layer 672 may be disseminated to the application programs 666 via the operating system 664, and vice versa.

The visual indicator 620 may be used to provide visual notifications, and/or an audio interface 674 may be used for producing audible notifications via the audio transducer 625. In the illustrated embodiment, the visual indicator 620 is a light emitting diode (LED) and the audio transducer 625 is a speaker. These devices may be directly coupled to the power supply 670 so that when activated, they remain on for a duration dictated by the notification mechanism even though the processor 660 and other components might shut down for conserving battery power. The LED may be programmed to remain on indefinitely until the user takes action to indicate the powered-on status of the device. The audio interface 674 is used to provide audible signals to and receive audible signals from the user. For example, in addition to being coupled to the audio transducer 625, the audio interface 674 may also be coupled to a microphone to receive audible input, such as to facilitate a telephone conversation. In accordance with embodiments of the present disclosure, the microphone may also serve as an audio sensor to facilitate control of notifications, as will be described below. The system 602 may further include a video interface 676 that enables an operation of an on-board camera 630 to record still images, video stream, and the like.

A mobile computing device 600 implementing the system 602 may have additional features or functionality. For example, the mobile computing device 600 may also include additional data storage devices (removable and/or non-removable) such as, magnetic disks, optical disks, or tape. Such additional storage is illustrated in FIG. 6B by the non-volatile storage area 668.

Data/information generated or captured by the mobile computing device 600 and stored via the system 602 may be stored locally on the mobile computing device 600, as described above, or the data may be stored on any number of storage media that may be accessed by the device via the radio interface layer 672 or via a wired connection between the mobile computing device 600 and a separate computing device associated with the mobile computing device 600, for example, a server computer in a distributed computing network, such as the Internet. As should be appreciated such data/information may be accessed via the mobile computing device 600 via the radio interface layer 672 or via a distributed computing network. Similarly, such data/information may be readily transferred between computing devices for storage and use according to well-known data/information transfer and storage means, including electronic mail and collaborative data/information sharing systems.

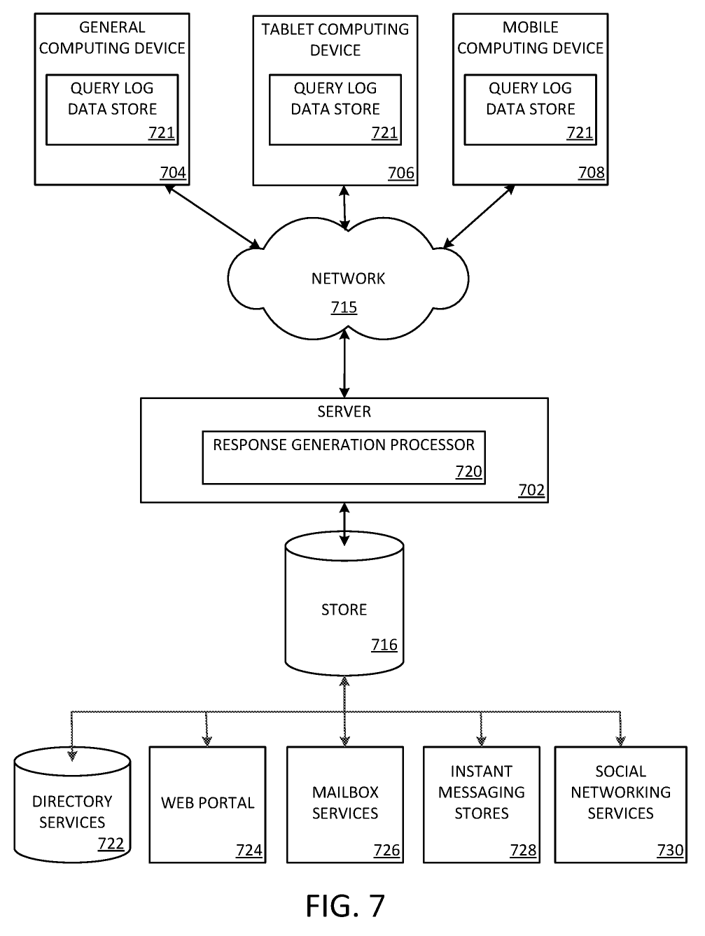

FIG. 7 illustrates one aspect of the architecture of a system for processing data received at a computing system from a remote source, such as a personal computer 704, tablet computing device 706, or mobile computing device 708, as described above. Content displayed at server device 702 may be stored in different communication channels or other storage types. For example, various documents may be stored using a directory service 722, a web portal 724, a mailbox service 726, an instant messaging store 728, or a social networking site 730. Query log data store 721 may be employed by a client that communicates with server device 702, and/or response generation processor 720 may be employed by server device 702. The server device 702 may provide data to and from a client computing device such as a personal computer 704, a tablet computing device 706 and/or a mobile computing device 708 (e.g., a smart phone) through a network 715. By way of example, the computer system described above may be embodied in a personal computer 704, a tablet computing device 706 and/or a mobile computing device 708 (e.g., a smart phone). Any of these embodiments of the computing devices may obtain content from the store 716, in addition to receiving graphical data useable to be either pre-processed at a graphic-originating system, or post-processed at a receiving computing system.

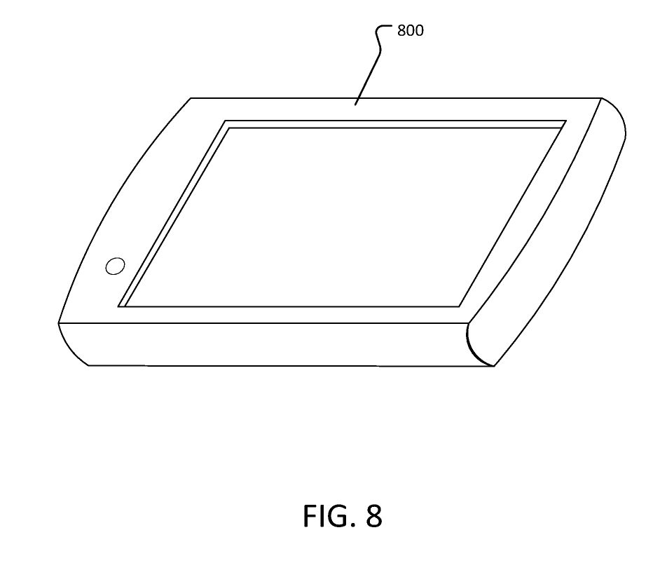

FIG. 8 illustrates an exemplary tablet computing device 800 that may execute one or more aspects disclosed herein. In addition, the aspects and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example user interfaces and information of various types may be displayed and interacted with on a wall surface onto which user interfaces and information of various types are projected. Interaction with the multitude of computing systems with which embodiments of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

As will be understood from the foregoing disclosure, one aspect of the technology relates to a system comprising: at least one processor; and memory storing instructions that, when executed by the at least one processor, causes the system to perform a set of operations. The set of operations comprises: determining, based on a received search query, a dataset comprising one or more suggested search queries, wherein the received search query relates to one or more image results; selecting a suggested search query from the dataset; generating, using the suggested search query, suggested content associated with the suggested search query, wherein the suggested content comprises a plurality of image search results associated with the suggested search query; and providing the suggested content to a client device for display to a user, wherein displaying the suggested content to the user comprises displaying the suggested content within a display of the one or more image results. In an example, selecting the suggested search query from the dataset comprises evaluating relevancy of queries in the dataset based on the received search query. In another example, the received search query comprises an entity and an intent, and wherein determining the dataset comprises selecting a dataset from the group consisting of: a dataset that varies the entity of the received search query; a dataset that varies the intent of the received search query; and a dataset that varies the scope of the received search query. In a further example, the suggested content is associated with multiple suggested queries from the dataset, and wherein the suggested content comprises an image search result for each of the multiple suggested queries. In yet another example, the suggested content comprises text indicating the suggested search query. In a further still example, determining the dataset comprises determining a dataset comprising suggested search queries that are related to the received search query. In an example, the set of operations further comprises: receiving, from the client device, a search query indication associated with one of the multiple suggested queries.

In another aspect, the technology relates to a method for generating a dataset for dynamic representation of suggested queries. The method comprises: accessing a search query log, wherein the search query log comprises a plurality of search queries; categorizing each of the plurality of search queries to identify query reformulations; generating one or more datasets based on the identified query reformulations; determining a suggested search query for a received search query from at least one of the one or more datasets; generating, using the suggested search query, suggested content associated with the suggested search query, wherein the suggested content comprises a plurality of search results associated with the suggested search query; and providing the suggested content to a client device for display to a user. In an example, categorizing each of the plurality of search queries to identify query reformulations comprises evaluating similarities among at least one of: the terms of each search query; and at least a part of the result set for each search query. In another example, generating the one or more datasets comprises: determining an entity and an intent for each query of a query reformulation; and storing each query in a dataset based on the determined entity and intent, wherein the dataset is at least one of: a dataset that varies the entity of stored search queries; a dataset that varies the intent of stored search queries; and a dataset that varies the scope of stored search queries. In a further example, determining the suggested search query from at least one of the one or more datasets comprises evaluating a relevancy of the queries in relation to the received search query. In yet another example, the suggested content is associated with multiple suggested queries, and wherein the suggested content comprises a search result for each of the multiple suggested queries. In a further still example, plurality of search queries and the received search query relate to image searches.

In a further aspect, the technology relates to a method for dynamic representation of suggested queries. The method comprises: determining, based on a received search query, a dataset comprising one or more suggested search queries, wherein the received search query relates to one or more query results; selecting a suggested search query from the dataset; generating, using the suggested search query, suggested content associated with the suggested search query, wherein the suggested content comprises a plurality of search results associated with the suggested search query; and providing the suggested content to a client device for display to a user, wherein displaying the suggested content to the user comprises displaying the suggested content within a display of the one or more query results. In an example, selecting the suggested search query from the dataset comprises evaluating relevancy of queries in the dataset based on the received search query. In another example, the received search query comprises an entity and an intent, and wherein determining the dataset comprises selecting a dataset from the group consisting of: a dataset that varies the entity of the received search query; a dataset that varies the intent of the received search query; and a dataset that varies the scope of the received search query. In a further example, the suggested content is associated with multiple suggested queries from the dataset, and wherein the suggested content comprises an image search result for each of the multiple suggested queries. In yet another example, the suggested content comprises text indicating the suggested search query. In a further still example, determining the dataset comprises determining a dataset comprising suggested search queries that are related to the search query. In an example, the query results and the search results are image search results.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A system comprising:
at least one processor; and
memory storing instructions that, when executed by the at least one processor, causes the system to perform a set of operations, the set of operations comprising:
determining, based on a received search query, a dataset comprising one or more suggested search queries, wherein the received search query relates to one or more image results;
selecting a suggested search query from the dataset;
generating, using the suggested search query, suggested content associated with the suggested search query, wherein the suggested content comprises a plurality of image search results associated with the suggested search query; and
providing the suggested content to a client device for display to a user, wherein displaying the suggested content to the user comprises displaying the suggested content within a display of the one or more image results.

2. The system of claim 1, wherein selecting the suggested search query from the dataset comprises evaluating relevancy of queries in the dataset based on the received search query.

3. The system of claim 1, wherein the received search query comprises an entity and an intent, and wherein determining the dataset comprises selecting a dataset from the group consisting of:
a dataset that varies the entity of the received search query;
a dataset that varies the intent of the received search query; and
a dataset that varies the scope of the received search query.

4. The system of claim 1, wherein the suggested content is associated with multiple suggested queries from the dataset, and wherein the suggested content comprises an image search result for each of the multiple suggested queries.

5. The system of claim 1, wherein the suggested content comprises text indicating the suggested search query.

6. The system of claim 1, wherein determining the dataset comprises determining a dataset comprising suggested search queries that are related to the received search query.

7. The system of claim 4, wherein the set of operations further comprises:
receiving, from the client device, a search query indication associated with one of the multiple suggested queries.

8. A method for generating a dataset for dynamic representation of suggested queries, comprising:
accessing a search query log, wherein the search query log comprises a plurality of search queries;
categorizing each of the plurality of search queries to identify query reformulations;
generating one or more datasets based on the identified query reformulations;
determining a suggested search query for a received search query from at least one of the one or more datasets;
generating, using the suggested search query, suggested content associated with the suggested search query, wherein the suggested content comprises a plurality of search results associated with the suggested search query; and
providing the suggested content to a client device for display to a user.

9. The method of claim 8, wherein categorizing each of the plurality of search queries to identify query reformulations comprises evaluating similarities among at least one of:
the terms of each search query; and
at least a part of the result set for each search query.

10. The method of claim 8, wherein generating the one or more datasets comprises:
determining an entity and an intent for each query of a query reformulation; and
storing each query in a dataset based on the determined entity and intent, wherein the dataset is at least one of:
a dataset that varies the entity of stored search queries;
a dataset that varies the intent of stored search queries; and
a dataset that varies the scope of stored search queries.

11. The method of claim 8, wherein determining the suggested search query from at least one of the one or more datasets comprises evaluating a relevancy of the queries in relation to the received search query.

12. The method of claim 8, wherein the suggested content is associated with multiple suggested queries, and wherein the suggested content comprises a search result for each of the multiple suggested queries.

13. The method of claim 8, wherein the plurality of search queries and the received search query relate to image searches.

14. A method for dynamic representation of suggested queries, comprising:
determining, based on a received search query, a dataset comprising one or more suggested search queries, wherein the received search query relates to one or more query results;
selecting a suggested search query from the dataset;
generating, using the suggested search query, suggested content associated with the suggested search query, wherein the suggested content comprises a plurality of search results associated with the suggested search query; and
providing the suggested content to a client device for display to a user, wherein displaying the suggested content to the user comprises displaying the suggested content within a display of the one or more query results.

15. The method of claim 14, wherein selecting the suggested search query from the dataset comprises evaluating relevancy of queries in the dataset based on the received search query.

16. The method of claim 14, wherein the received search query comprises an entity and an intent, and wherein determining the dataset comprises selecting a dataset from the group consisting of:
a dataset that varies the entity of the received search query;
a dataset that varies the intent of the received search query; and
a dataset that varies the scope of the received search query.

17. The method of claim 14, wherein the suggested content is associated with multiple suggested queries from the dataset, and wherein the suggested content comprises an image search result for each of the multiple suggested queries.

18. The method of claim 14, wherein the suggested content comprises text indicating the suggested search query.

19. The method of claim 14, wherein determining the dataset comprises determining a dataset comprising suggested search queries that are related to the search query.

20. The method of claim 14, wherein the query results and the search results are image search results.
